(19) United States
(12) Patent Application Publication
(10) Pub. No.: US 2006/0076300 A1
(43) Pub. Date: Apr. 13, 2006

(54) System and method for reducing runoff of grease and similar effluents from restaurants and like facilites

(76) Inventor: Ricky L. Mitchell, Jacksonville, FL (US)

Correspondence Address: Allen, Dyer, Doppelt, Milbrath & Gilchrist, P.A.;Suite 1401, 255 South Orange Avenue, P.O. Box 3791, Orlando, FL, 32802-3791, US

(21) Appl. No.: 11/244,809

(22) Filed: Oct. 6, 2005

Related U.S. Application Data
(60) Provisional application No. 60/616,469, filed on Oct. 6, 2004.

(51) Int. Cl. B01D 17/028

(52) U.S. Cl. 210/800; 210/538

(57) ABSTRACT

Fouling of traps from grease and similar effluents from restaurants and like facilities is reduced by using a concrete grease trap having an internal baffle plate, with an impervious liner fitted within the grease trap to restrict the outflow of grease and to prevent intrusion of grease into the walls of the concrete trap.

### CROSS-REFERENCE TO RELATED APPLICATIONS

This application claims the benefit of U.S. Provisional Application No. 60/616,469, filed Oct. 6, 2004, the disclosure of which is hereby incorporated by reference herein in its entirety, and which is commonly owned with this application.

### FIELD OF INVENTION

The present invention generally relates to systems and methods for treating grease and similar effluents in wastewater outputs from restaurants and like facilities.

### BACKGROUND

It is well known to place a liner with a concrete tank such as a septic tank or waste disposal tank. See, for example, the following United States patents and published applications: U.S. Pat. No. 4,613,922 to Bachmann; U.S. Pat. No. 3,662,918 to Crawford et al.; U.S. Pat. No. 3,898,162 to Carlson et al.; U.S. Pat. No. 3,957,416 to Kaempen; U.S. Pat. No. 4,162,976 to Monson; U.S. Pat. No. 4,465,594 to Laak; U.S. Patent No. RE31,753 to LaVergne Jr.; U.S. Pat. No. 5,044,778 to Hines; U.S. Pat. No. 5,101,849 to Richard; U.S. Pat. No. 5,454,544 to Del Zotto; U.S. Pat. No. 5,582,310 to Del Zotto; U.S. Pat. No. 5,601,204 to Hall; U.S. Pat. No. 5,772,361 to Gavin; U.S. Pat. No. 5,799,817 to Sharp; U.S. Pat. No. 6,202,370 to Miller et al.; U.S. Pat. No. 6,206,226 to Coates; U.S. Publication No. 2001/0025853 to Piehler; U.S. Pat. No. 6,387,524 to Finefrock; U.S. Pat. No. 6,606,836 to Miller; U.S. Publication No. 2004/0245255 to Copley et al.; U.S. Publication No. 2005/0184000 to Jowett.

### SUMMARY

The present invention is directed to a system and method for reducing runoff of grease and similar effluents from restaurants and like facilities where the grease and effluents are injected into either a conventional local drainage facility or into a municipal waste water system.

In a preferred embodiment, a hollow concrete grease trap shell is provided with a liner impervious to grease and effluents with an internal baffle to separate the grease from any liquid effluent, to thereby significantly reduce the amount of grease injected into a drain field associated with the grease trap shell. The plastic (i.e., polyethylene) liner prevents invasion of the grease and other effluents through the concrete wall of the outer shell. Other features, such as a sealing cap are utilized to further reduce grease and effluent intrusion into the shell.

The plastic liner may be inserted into the concrete shell at the manufacturing facility, or alternatively installed into an existing grease trap. In either event, the plastic liner is welded at the corners to form a watertight seal.

### BRIEF DESCRIPTION OF DRAWINGS

For a fuller understanding of the invention, reference is made to the following detailed description, taken in connection with the accompanying drawings and photographs illustrating various embodiments of the present invention, in which:

FIG. 1 is a schematic illustration of a restaurant facility having a grease trap and drain field of the type which may utilize the system and method of the present invention.

FIG. 2 is a schematic illustration of a restaurant facility having a grease trap coupled to a municipal treatment system.

FIG. 3 is an exploded perspective view of a prefabricated tank liner inserted into a concrete tank.

FIG. 4 is a partial perspective view of a concrete tank prior to having a liner inserted therein.

FIG. 5 is a partial perspective view of a concrete tank having a partition wall therein in accordance with an alternate embodiment.

FIG. 6 is a side perspective view illustrating a first embodiment of a prefabricated tank liner.

FIG. 7 is an end elevation view of the prefabricated liner of FIG. 6.

FIG. 8 is a perspective view of an inside portion of the prefabricated liner of FIGS. 6 and 7.

FIG. 9 is a partial cross sectional view of a portion of the concrete shell-plastic liner construction, illustrating the upper sealing cap feature.

FIG. 10 is a cross sectional illustration of a grease trap in accordance with the present invention.

### DETAILED DESCRIPTION OF THE INVENTION

The present invention will now be described more fully with reference to the accompanying drawings in which alternate embodiments of the invention are shown and described. It is to be understood that the invention should not be construed as limited to the illustrated embodiments set forth herein. Rather, these embodiments are provided so that this disclosure may be thorough and complete, and will convey the scope of the invention to those skilled in the art.

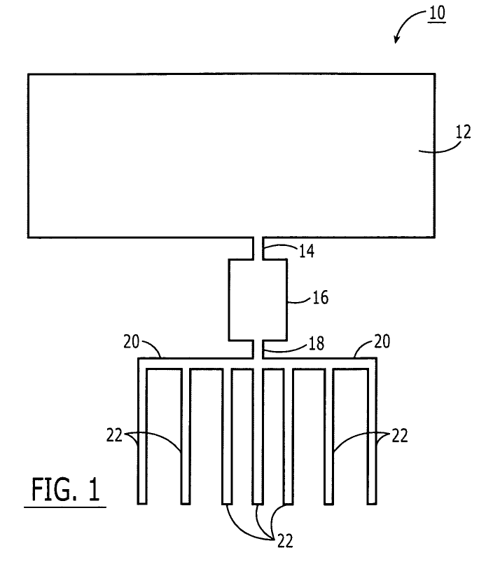

First noting FIG. 1, the system and method of the present invention is useful in an installation, referred to generally by 10, where a restaurant 12 has an outflow 14 to a grease trap 16. Typically, when the grease trap is not connected to a municipal waste water system, the grease trap 16 is provide with an outflow 18 to a conventional drainage field, including lateral mainlines 20 and individual feeder lines 22, through which the effluent from the grease trap is extended through the soil for anaerobic treatment and percolation. When the restaurant 12 is generating a significant amount of excess grease into the trap 16, frequently the grease will flow into the drain field lines 20, 22. This can cause not only blockage of the percolating openings of the lines 20, 22, but can also create environmental hazards. Many local and state ordinances contain specific restrictions on the amount of grease effluent that can be emitted into a drain field. More importantly, however, is the effect that grease and similar effluents can cause within the grease trap 16. It is well known that concrete is somewhat porous, and that grease will migrate into and through a concrete barrier. Therefore, in accordance with the present invention, an impervious liner and barrier system has been developed which resolves many of the above-noted problems with conventional concrete grease traps.

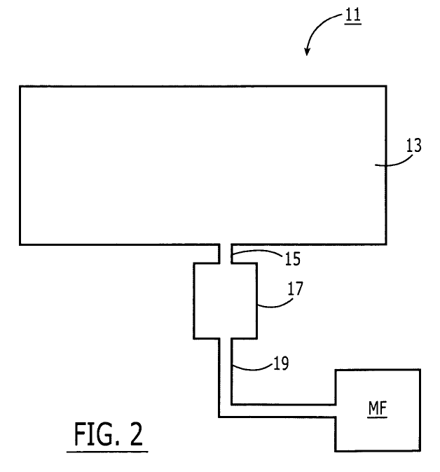

The system and method of this invention is also useful with a restaurant or like facility that is coupled to a municipal wastewater treatment facility, as shown in FIG. 2. In this arrangement, the installation 11 with restaurant 13 having an outflow 15 coupled to a grease trap 17. Outflow 19 is coupled in a conventional manner to a municipal wastewater facility MF.

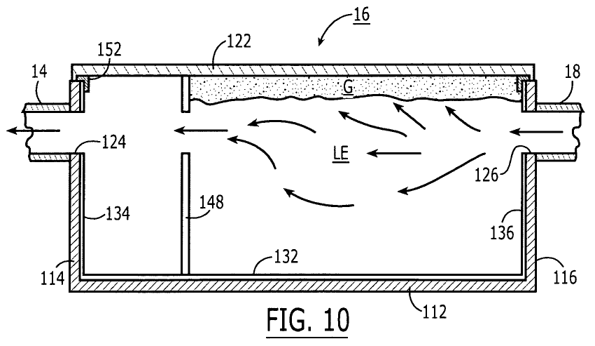

As will be understood by those skilled in the art from a review of the cross-section of FIG. 10 and the description set out below, a grease trap in accordance with this invention has an impervious sidewall and end wall construction that protects the walls of a concrete shell while providing an efficient trap for grease entrained with liquid effluent.

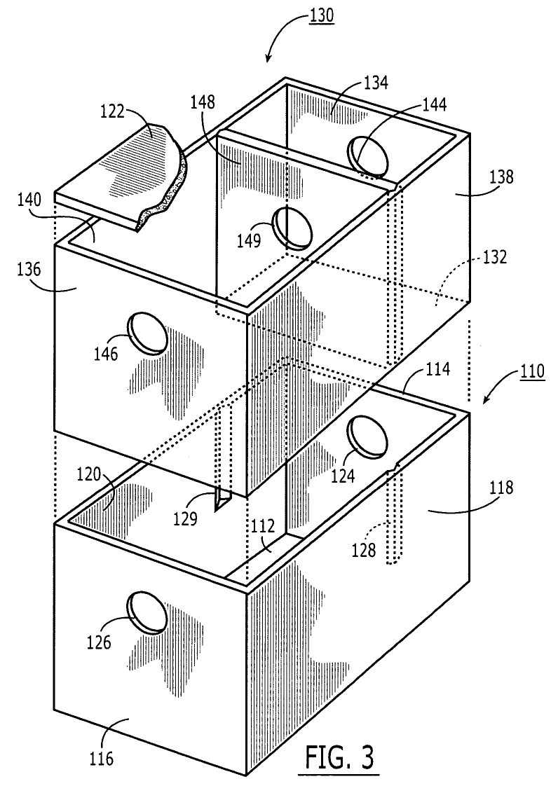

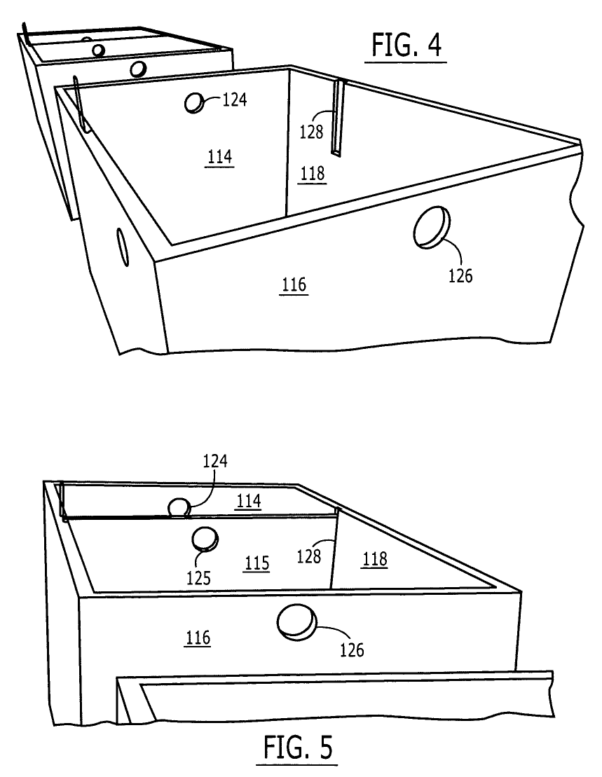

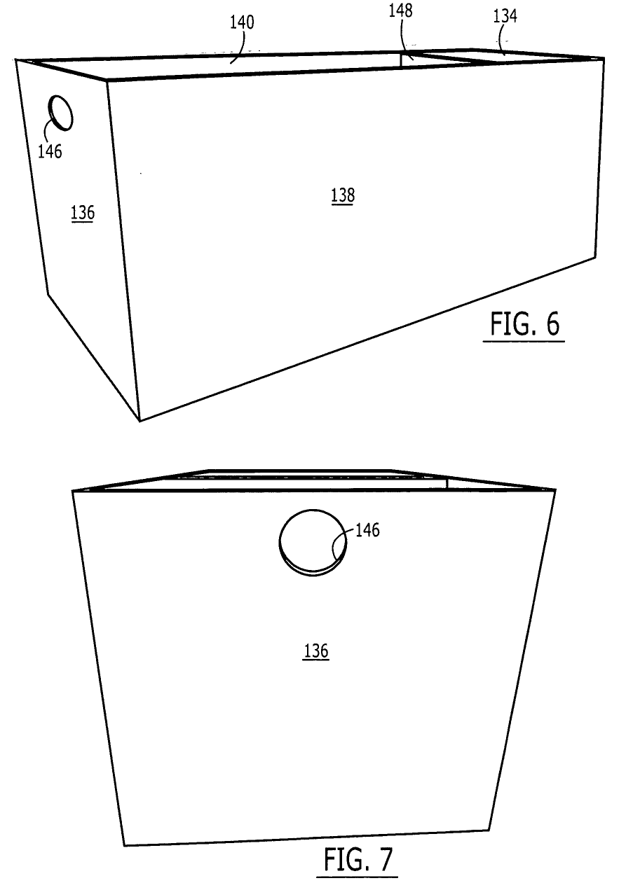

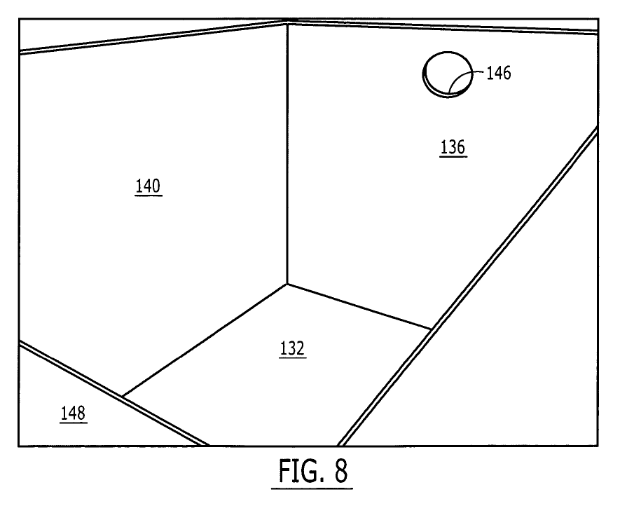

Now noting FIG. 3, one embodiment of a grease trap in accordance with the present invention includes a concrete outer shell 110 having a bottom 112, end walls 114, 116 and opposing sidewalls 118, 120. A cover 122 encloses the entire construction. The concrete shell has an outlet opening 124 in the end wall 114 and an inlet opening 126 in the opposing end wall 116. A plastic liner 130 is provided, and may be installed either at the manufacturing facility directly into the concrete shell 110 or alternatively may be installed on site at a grease trap location. In the embodiment of FIG. 3, the plastic liner, which may comprise sheet polypropylene, for example, has a bottom 132 opposing end walls 134, 136 and opposing sidewalls 138 and 140. The liner end wall 134 has an outlet 144 and the opposing end wall 136 has an inlet 146.

Further in accordance with the present invention, the embodiment of the liner 130 shown in FIG. 3 includes a vertical baffle plate 148 extending between the opposing end walls 134, 136 between the opposing sidewalls 138, 140. As shown in FIG. 2, the baffle 148 is positioned further from the end wall 136 having the opening 146, as described below, so as to form a grease retention volume between the baffle 148 and the end wall 136 (see FIG. 10).

In accordance with another aspect of the present invention, the concrete shell 110 may be provided with opposing slots 128, 129 in the opposing sidewalls 118, 120 so as to permit the insertion of a concrete baffle 115, as shown in FIG. 5. In that instance, the plastic liner is formed of two parts, a first part to surround the volume adjacent the opening 114, and a second plastic liner fitted in the volume defined by the end wall 116 and the remaining portions of the opposing side walls 118, 120.

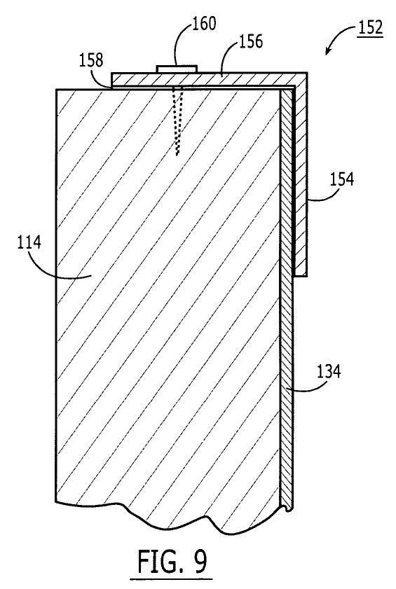

Another aspect of the preferred embodiment is shown in FIG. 9, which depicts a ceiling cap 152 comprising an L-shaped member of plastic liner material (e.g. polypropylene) having a vertically extending arm 154 and a horizontally extending arm 156. The cap 152 is preferably caulked to the top of the concrete wall, for example end wall 114, with a bead of silicon caulking material 158. A tap-end fastener 160 may also be utilized to ensure that the cap member 152 remains in place.

A cross section of the embodiment of FIG. 2 is illustrated in FIG. 10. As shown there, the volume between the end wall 136 and the baffle 148 forms a reservoir for grease G across the top of the reservoir, since the grease G is lighter than the liquid effluent LE. The liquid effluent LE flows through the opening 149 in the baffle 148 and into the volume defined between the baffle 148 and the opposing end wall 134. As the level of the liquid effluent LE reaches the opening 124, the liquid effluent LE flows through the outflow 18 into a connected drain field lines 20, 22 (FIG. 1) or into a municipal wastewater treatment facility MF (FIG. 2).

Many modifications and other embodiments of the invention will come to the mind of one skilled in the art having the benefit of the teachings presented in the foregoing descriptions and the associated drawings. Therefore it is to be understood that the invention is not to be limited to the specific embodiments disclosed, and that modifications and alternate embodiments are intended to be included within the scope of the claims supported by this specification.

That which is claimed is:

1. A method for reducing grease intrusion into a concrete grease trap and into an associated drain field, the method comprising the steps of:
providing a concrete grease trap having a bottom width opposing first and second end walls and opposing first and second sidewalls extending vertically from the bottom to define a volume adapted to receive effluent having grease entrained therein;
fitting an inlet opening through a first one of the end walls and an outlet opening through the opposing second end wall;
installing within the volume of the grease trap a vertical baffle plate having an opening therein, the baffle plate extending from the bottom between the sidewalls at a location substantially closer to the outlet end wall in order to form a reservoir for grease along the top of the grease trap between the inlet end wall and the baffle;
installing impervious liner means within the grease trap along the bottom, the end walls and the sidewalls; and
fitting a cover over the grease trap.

2. The method recited in claim 1 further comprising the step of fitting the inlet end of the grease trap to an outflow from a restaurant or like facility which is served by a municipal waste water treatment system.

3. The method recited in claim 1 further comprising the step of fitting the inlet end of the grease trap to an outflow from a restaurant or like facility having a local drain field system.

4. The method recited in claim 1 further comprising the step of forming the baffle plate of an impervious plastic.

5. The method recited in claim 1 further comprising the step of forming the baffle plate of concrete.

6. The method recited in claim 5 further comprising the step of installing the impervious liner means along the vertical sides of the baffle plate.

7. A system for reducing grease intrusion into a concrete grease trap, comprising:
a concrete grease trap having a bottom with opposing first and second end walls and opposing first and second sidewalls extending vertically from the bottom to define a volume adapted to receive effluent having grease entrained therein;
an inlet opening fitted through a first one of the end walls and an outlet opening fitted through the opposing second end walls;
a vertical baffle plate within the volume of the grease trap and having an opening therein, the baffle plate extending from the bottom between the opposing sidewalls at a location substantially closer to the outlet end wall in order to define a reservoir for grease along the top of the grease trap between the inlet end wall and the baffle;
impervious liner means within the volume of the grease trap along the bottom, end wails and sidewalls; and
a cover fitted over the grease trap.

8. The system recited in claim 7 wherein the baffle plate is formed of an impervious plastic.

9. The system recited in claim 7 wherein the baffle plate is formed of concrete.

10. The system recited in claim 9 wherein the impervious liner means is installed along the vertical sides of the baffle plate.

11. The system recited in claim 7, further comprising a sealing cap of impervious material along the top edge of each end and sidewall and overlying the top of each such wall.
